(19) United States
(12) Patent Application Publication
(10) Pub. No.: US 2009/0172647 A1
(43) Pub. Date: Jul. 2, 2009

(54) SYSTEM AND METHOD FOR MODEL DRIVEN UNIT TESTING ENVIRONMENT

(76) Inventor: TARUN TELANG, Bhilai (IN)

Correspondence Address: SAP AG, 3410 HILLVIEW AVENUE, PALO ALTO, CA, 94304, US

(21) Appl. No.: 11/967,283

(22) Filed: Dec. 31, 2007

(51) Int. Cl. G06F 9/455

(52) U.S. Cl. 717/135

(57) ABSTRACT

Embodiments of the invention are generally directed to a system and method for software program testing using a unit testing environment. A model having qualifiers is created using a modeling tool. A markup language meta-model is generated using the earlier created model. A unit test, generated using the markup language meta-model and the code or source code are stored in a code repository or source code repository. During execution, the unit test environment synchronizes the code from the code repository and reports are generated based on the unit test execution.

### FIELD OF THE INVENTION

The invention generally relates to a system and method for data processing system. More particularly, the invention relates to systems and methods for modeling a test environment during a software development life cycle.

### BACKGROUND OF THE INVENTION

Software program testing is an important phase of the software development life cycle. During software program testing, software program code is tested and the defects are fixed. This software program testing process is used to measure the quality of developed software.

Several software program testing processes are in use today. One of the software program testing procedures is called as unit testing. Unit testing is a procedure used to validate whether individual units of source code are working properly. A unit is the smallest testable part of a software program. In procedural programming a unit may be an individual program, function, procedure while in object-oriented programming it may be a class. The goal of unit testing is to isolate each part of the software program and check whether the individual parts are correct. Unit testing is the cornerstone of Extreme Programming (XP), which relies on an automated unit testing framework. Extreme Programming uses the creation of unit tests for test-driven development. A developer writes a unit test that exposes either a software requirement or a defect. This test will fail if the requirement is not implemented, or if it exposes a defect in the existing code. Then, the developer writes the simplest code to make the test, along with other tests, pass. All classes in the system are unit tested.

Unit testing is a time consuming and cumbersome activity as developers have to test to validate that each individual function module or unit of code is working as expected. Therefore, there is a need for providing a system that can ease this cumbersome and tedious task of unit testing. Further there is a need for providing a model driven unit testing environment.

### SUMMARY OF THE INVENTION

Embodiments of the invention are generally directed to a system and method for software program testing using a unit testing environment. A model having qualifiers is created using a modeling tool. A markup language meta-model is generated using the earlier created model. A unit test, generated using the markup language meta-model and the code or source code are stored in a code repository or source code repository. During execution, the unit test environment synchronizes the code from the code repository and reports are generated based on the unit test execution.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a flow diagram illustrating a method for providing a model driven unit testing environment, according to an embodiment of the invention.

FIG. 2 is a system block diagram of an implementation for generating a model driven unit testing environment, according to an embodiment of the invention.

FIG. 3 is a graphical user interface of the modeling tool used for creating a model with qualifiers, according to an embodiment of the invention.

FIG. 4 is a graphical user interface of the modeling tool used for generating markup language meta-model, according to an embodiment of the invention.

FIG. 5 is a graphical user interface of the modeling tool used for generating and modifying unit test, according to an embodiment of the invention.

FIG. 6 is a graphical user interface of the modeling tool used for storing unit test, according to an embodiment of the invention.

FIG. 7 is a graphical user interface of the modeling tool used for executing the test environment, according to an embodiment of the invention.

FIG. 8 is a graphical user interface of the modeling tool used for generating reports of the unit test execution, according to an embodiment of the invention.

### DETAILED DESCRIPTION

Embodiments of the invention are generally directed to a system and method for software program testing using a unit testing environment. A model having qualifiers is created using a modeling tool. A markup language meta-model is generated using the earlier created model. A unit test, generated using the markup language meta-model and the code or source code are stored in a code repository or source code repository. During execution, the unit test environment synchronizes the code from the code repository and reports are generated based on the unit test execution.

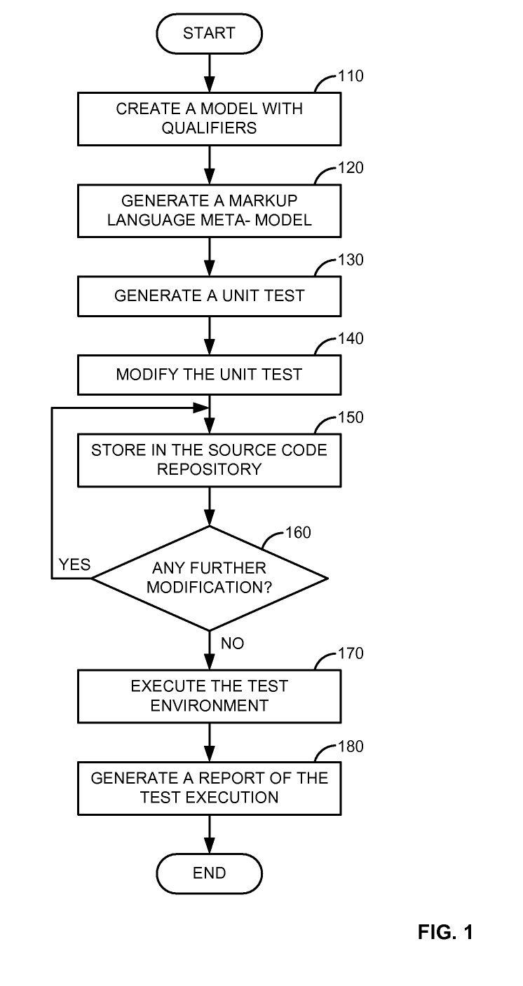

FIG. 1 is a flow diagram illustrating a method for providing a model driven unit testing environment, according to an embodiment of the invention. At process block 11 0, a model with qualifiers is created. Qualifiers are elements of software model which introduces provision to accommodate details about tests and the qualifiers specify the generation of unit tests for the model. In an embodiment, generating a unit test includes a testing technique for testing a unit of the code. At process block 120, the model generates a markup language meta-model. At process block 130, the markup language meta-model is used to generate unit tests. At process block 140, the generated unit tests can be modified. In an embodiment, the unit tests are modified using an integrated development environment. At process block 150, the code is stored in a code repository. At decision point 160, if there are any further modifications then the process proceeds to process block 150, where the code is stored in the code repository. At decision point 160, if there are no further modifications, then at process block 170, the unit test environment is executed. In an embodiment, the execution environment is scheduled to download the latest code from the code repository and execute the unit tests either in a test server or in a standalone environment. In an embodiment, executing the test environment includes synchronizing the code from the code repository. In an embodiment, executing the test environment includes compiling the code to produce object code. At process block 180, a report of the unit test execution is generated, reporting the result in a desired format. In an embodiment, the report is generated based on the result of the unit test.

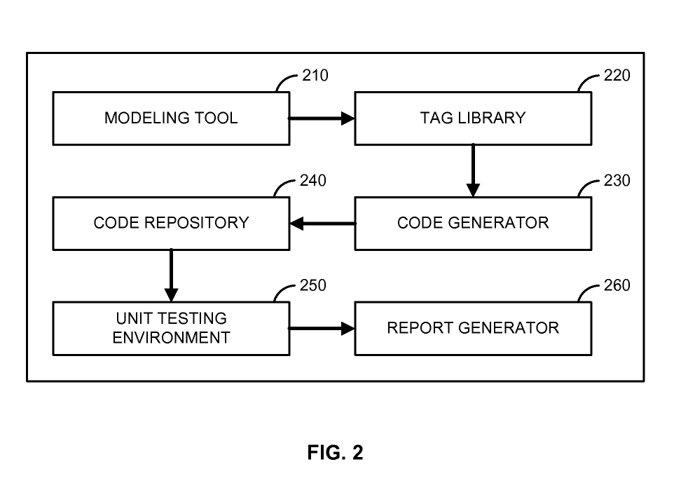

FIG. 2 is a system block diagram of an implementation for generating a model driven unit testing environment, according to an embodiment of the invention. The system comprises of a modeling tool 210, a tagging library 220, a code generator 230, a code repository 240, a unit testing environment 250 and a report generator 260. Modeling tool 210 supports qualifiers and is used for preparing the software program. The models are stored in the form of markup language representation in tag library 220. Code generator 230 performs conversion of markup language representation to generate code and unit test code in different languages and vice versa. Code repository 240 stores the modified code and the unit test code. Code repository 240 allows further modification of the generated code and unit testing code. Unit testing environment 250 executes the unit tests after automatically downloading the latest code and the unit test code from code repository 240. Report generator 260 generates the report for the unit test execution. In an embodiment, an integrated development environment is used for software program development.

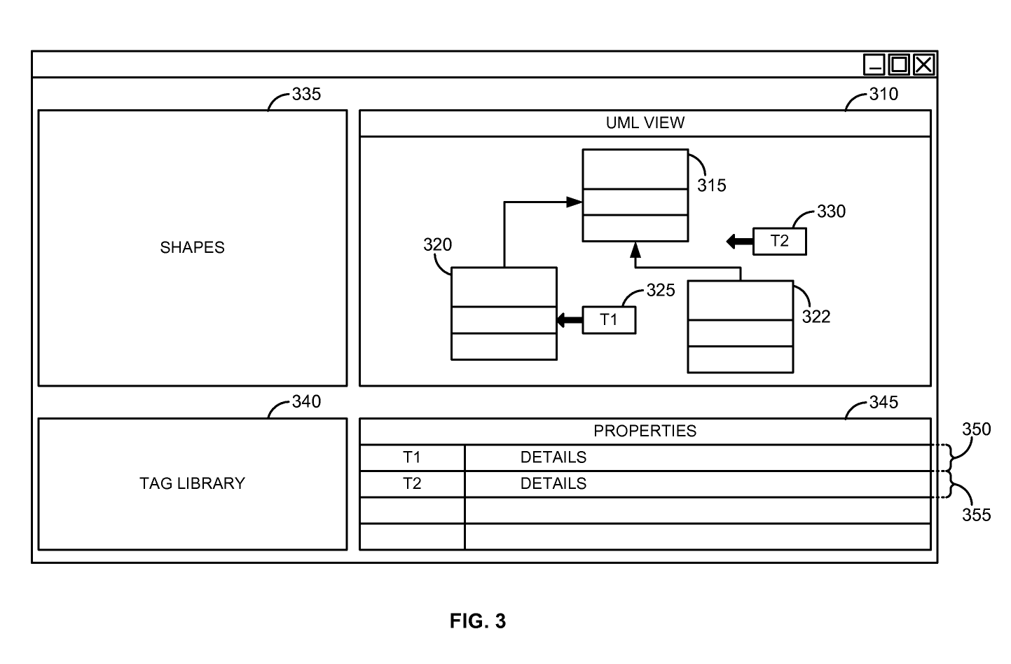

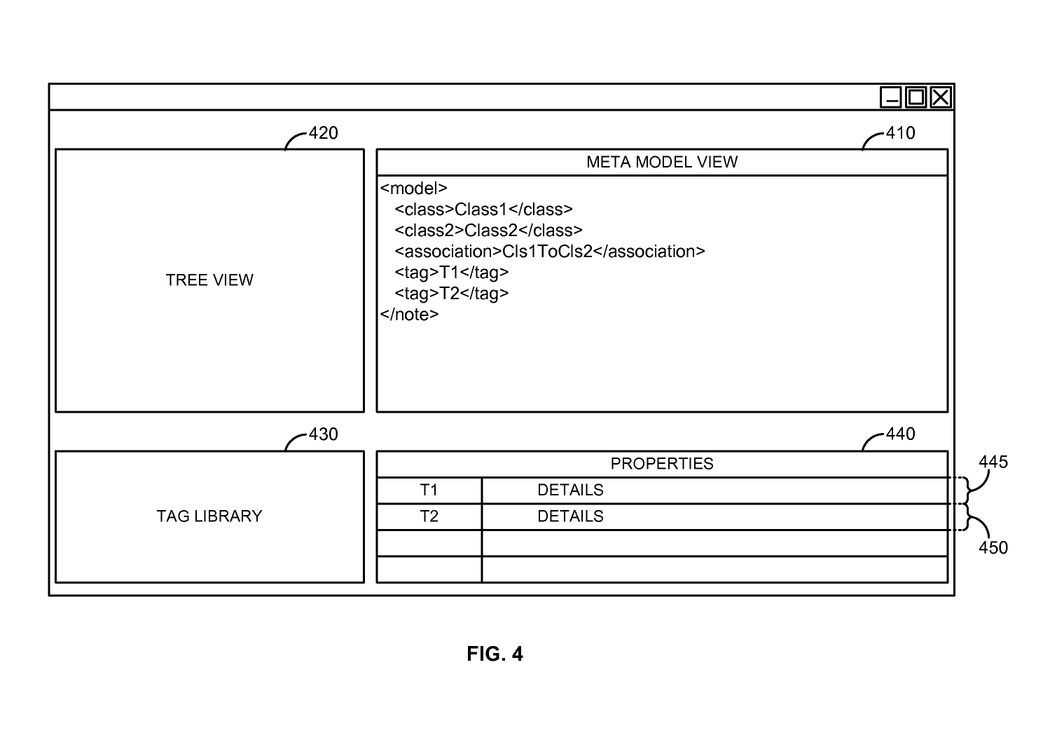

FIG. 3 is a graphical user interface of the modeling tool used for creating a model with qualifiers, according to an embodiment of the invention. As depicted, UML View 310 depicts several parts of code 315, code 320 and code 322 along with unit test 325 and unit test 330. Shapes 335 provides a choice from several templates of shapes. Tag library 340 provides several tags or qualifiers that can be added to the model. Properties 345 describe in detail the properties of test T1 350 and test T2 355. An user creates an UML and later can generate meta-model as depicted in FIG. 4

FIG. 4 is a graphical user interface of the modeling tool used for generating markup language meta-model, according to an embodiment of the invention. As depicted, meta-model view 410 has several lines of code along with qualifiers. A graphical user interface is displaying tree view 420. Tag library 430 provides several tags or qualifiers that can be added to the model. Properties 440 describe in detail the properties of qualifier T1 455 and qualifier T2 450.

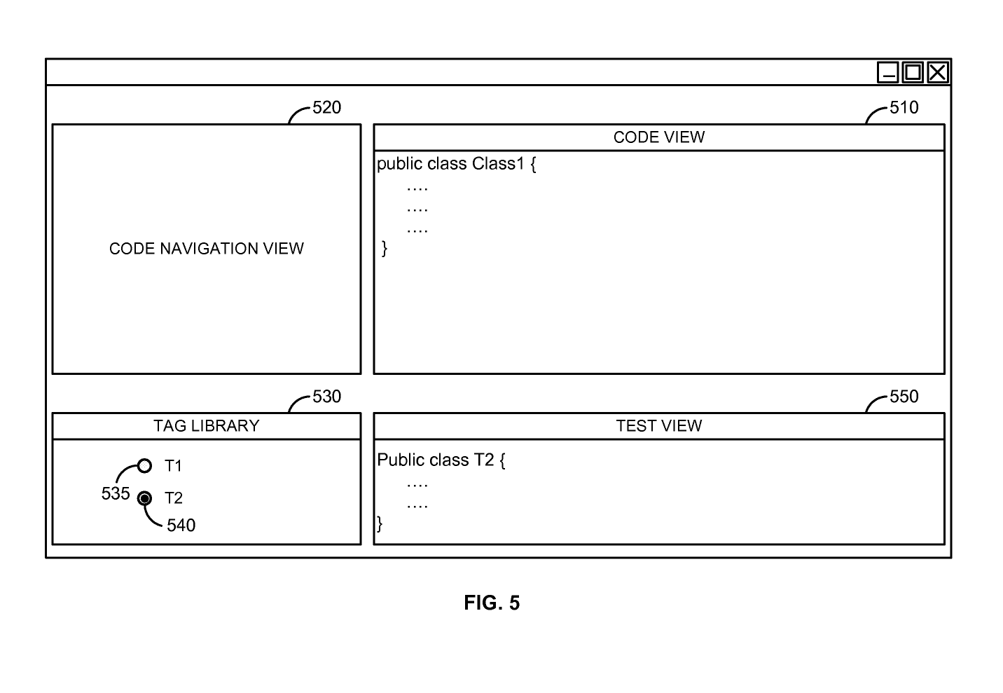

FIG. 5 is a graphical user interface of the modeling tool used for generating and modifying unit test, according to an embodiment of the invention. As depicted, code view 510 depicts a generated model that can be also be modified. A graphical user interface is displaying code navigation view 520. Tag library 530 depicts the test view of test T1 535 and test T2 540. Test view 550 depicts the code of the test T2 540 that can also be modified.

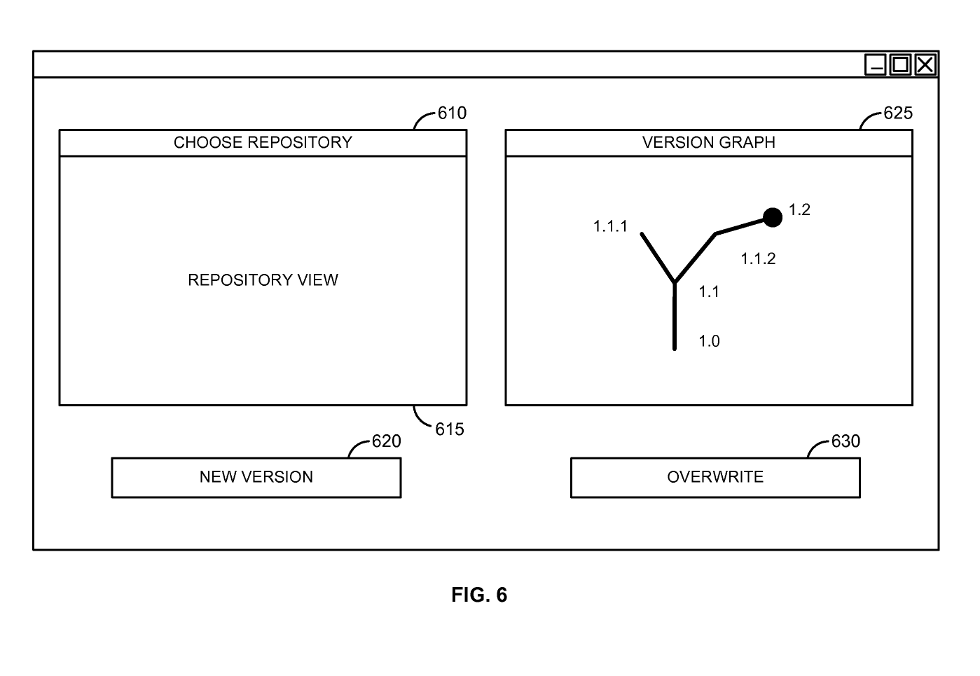

FIG. 6 is a graphical user interface of the modeling tool used for storing test, according to an embodiment of the invention. As depicted, choose repository 610 provides for selecting the repository along with repository view 615 of the chosen repository. New version 620 can also be selected. Version graph 625 depicts the version graph of the model. Overwrite 630 can overwrite version graph 625.

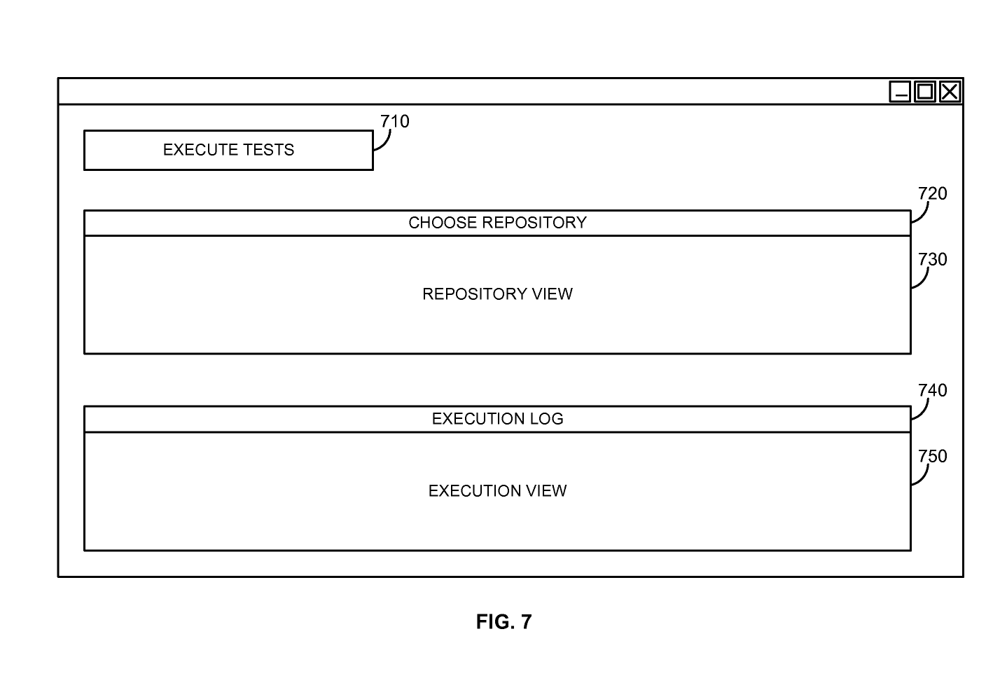

FIG. 7 is a graphical user interface of the modeling tool used for executing the test environment, according to an embodiment of the invention. As depicted, on selecting execute test 710, choose repository 720 is depicted in repository view 730. Execution log 740 provides execution view 750.

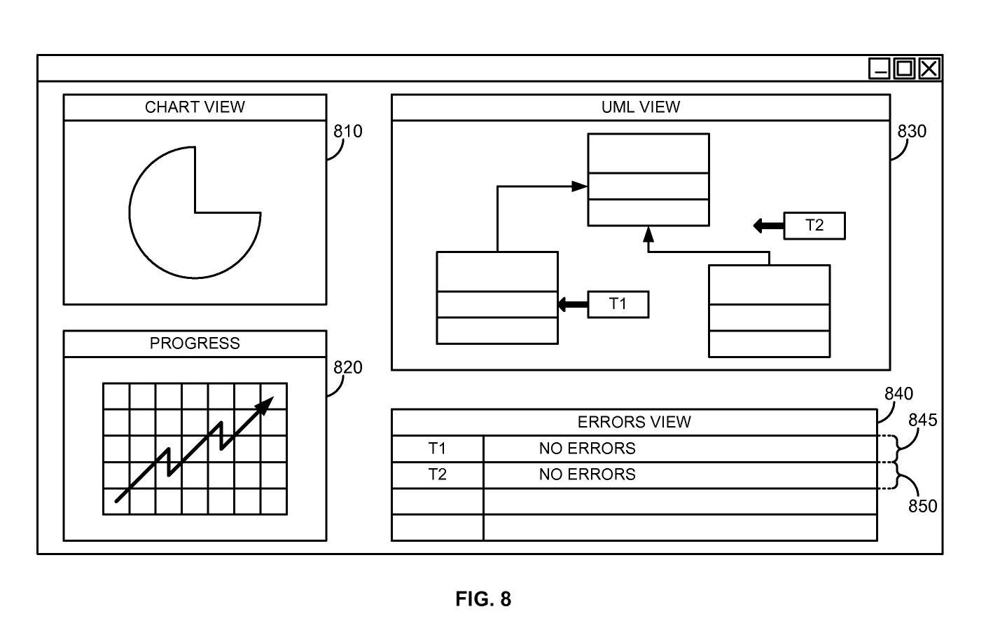

FIG. 8 is a graphical user interface of the modeling tool used for generating reports of the test execution, according to an embodiment of the invention. As depicted, the report of the test execution can be depicted either as chart view 810, or as progress graph 820. UML view 830 provides the graphical view and the errors are displayed in errors views 840. Errors view 840 lists the corresponding errors against respective qualifiers such as T1 845 and T2 850.

Other embodiments of the invention may be implemented in digital electronic circuitry, or in computer hardware, firmware, software, or in combinations of them.

Elements of the invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions.

Throughout the foregoing description, for the purposes of explanation, numerous specific details were set forth in order to provide a thorough understanding of the invention. It will be apparent, however, to one skilled in the art that the invention may be practiced without some of these specific details. The underlying principles of the invention may be employed using a virtually unlimited number of different types of input data and associated actions.

Accordingly, the scope and spirit of the invention should be judged in terms of the claims which follow.

What is claimed is:

1. A method for software program testing, comprising:
creating a model with qualifiers;
generating a markup language meta-model from the model;
generating a unit test using the markup language meta-model;
executing a test environment on a code from a code repository and the unit test; and
generating a report based on the test execution environment.

2. The method in claim 1, wherein creating a model comprises using a modeling tool having support for qualifiers.

3. The method in claim 1, wherein generating a unit test comprises a testing technique for testing a unit of the code.

4. The method in claim 1, further comprising modifying the unit test using the markup language meta-model.

5. The method in claim 1, further comprises storing the code and unit test code in a code repository.

6. The method in claim 1, wherein executing a test environment comprises synchronizing the code from the code repository.

7. The method in claim 1, wherein executing a test environment comprises compiling the code to produce object code.

8. The method in claim 1, wherein generating a report comprises automatically generating a report.

9. The method in claim 1, wherein generating a report comprises generating a report based on the result of the unit test.

10. An article of manufacture comprising:
a machine readable medium having instructions that when executed by a machine cause the machine to execute a method, comprising:
creating a model with qualifiers;
generating a markup language meta-model from the model;
generating a unit test using the markup language meta-model;
executing a test environment on a code from a code repository and the unit test; and
generating a report based on the test execution environment.

11. The article of manufacture in claim 10, wherein creating a model comprises using a modeling tool having support for qualifiers.

12. The article of manufacture in claim 10, wherein generating a unit test comprises a testing technique for testing a unit of the code.

13. The article of manufacture in claim 10, further comprising modifying the unit test using the markup language meta-model.

14. The article of manufacture in claim 10, further comprises storing the unit test and code in a code repository.

15. The article of manufacture in claim 10, wherein executing a unit test environment comprises synchronizing the code from the code repository.

16. The article of manufacture in claim 10, wherein executing a test environment comprises compiling the code to produce object code.

17. The article of manufacture in claim 10, wherein generating a report comprises of automatically generating a report.

18. The article of manufacture in claim 10, wherein generating a report comprises generating a report based on the result of the unit test.

19. A system, comprising:
a modeling tool for creating a model with qualifiers;
a tag library electronically coupled to the modeling tool to support the qualifiers;
a code generator electronically coupled to the tagging library to provide conversion of a markup language meta-model to generate code;
a code repository electronically coupled to the code generator to store the code and a unit test;
a unit test environment electronically coupled to the code repository to execute the unit test using the code repository and the unit test; and
a report generator electronically coupled to the unit test environment to generate report for the unit test execution.

20. The system in claim 19, further comprising using an integrated development environment for a software program development.
